(19) United States
(12) Patent Application Publication
(10) Pub. No.: US 2012/0140842 A1
(43) Pub. Date: Jun. 7, 2012

(54) SIGNALING TO PROTECT ADVANCED RECEIVER PERFORMANCE IN WIRELESS LOCAL AREA NETWORKS (LANS)

(75) Inventors: Sameer Vermani, San Diego, CA (US); Albert Van Zelst, Woerden (NL); Hemanth Sampath, San Diego, CA (US); Didier Johannes Richard Van Nee, De Meern (NL); Santosh Paul Abraham, San Diego, CA (US)

(73) Assignee: QUALCOMM INCORPORATED, San Diego, CA (US)

(21) Appl. No.: 13/311,389

(22) Filed: Dec. 5, 2011

Related U.S. Application Data
(60) Provisional application No. 61/420,199, filed on Dec. 6, 2010.
(60) Provisional application No. 61/423,433, filed on Dec. 15, 2010.

(51) Int. Cl. H04L 27/00; H04B 1/04

(52) U.S. Cl. 375/295; 455/129

(57) ABSTRACT

Certain aspects of the present disclosure relate to techniques that may be used to help control aspects of beamforming by a beamformee. According to certain aspects, a beamformee may be able to signal, to a beamformer, a maximum number of transmit spatial streams to use for single-user beamformed transmissions.

### CLAIM OF PRIORITY UNDER 35 U.S.C. §119

This application claims benefit of U.S. Provisional Patent Application Ser. No. 61/420,199 filed Dec. 6, 2010, and U.S. Provisional Patent Application Ser. No. 61/423,433 filed Dec. 15, 2010, which are both assigned to the assignee hereof and hereby expressly incorporated by reference herein.

### TECHNICAL FIELD

Certain aspects of the present disclosure generally relate to wireless communication and, more particularly, to techniques to allow a device to control beamforming of a transmission signal sent to the device.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple Input Multiple Output (MIMO) technology represents one such approach that has recently emerged as a popular technique for next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

Some systems may employ beamforming on one or more antennas in order to provide both spatial diversity and array gains. Beamforming may not always be beneficial, however. For example, in s utilizing Nt transmit antennas and Nr receive antennas, beyond a certain number of spatial streams it may not be beneficial to perform beamforming for transmissions (as compared to performing open loop transmissions) when the receiver utilizes an advanced algorithm, such as maximum likelihood (ML) detection. This is because if the transmitter has already cleaned up the interference across streams-via beamforming, the power of an advanced receiver may be wasted.

In the 802.11n system, the beamformee (device receiving the beamformed transmission) is in complete control of the sounding feedback dimension. Thus, in cases, where it has an advanced receiver (e.g., ML receiver), it can control the feedback dimension, so that the beamformer (device receiving the beamformed transmission) cannot send beyond a certain number of spatial streams using transmit beamforming. However, other systems, such as in 802.11 ac systems, this may no longer be the case as a beamformer (e.g., an AP) can be given control of the feedback dimension with the introduction of MU-MIMO.

Therefore, there is a need in the art for methods to efficiently control whether beamforming is applied to transmissions, for example, when a beamformee has an advanced receiver.

### SUMMARY

Certain aspects provide a method for wireless communications. The method generally includes determining information relating to transmissions from a transmitting entity, determining a maximum number of spatial streams for a beamformed transmission to be received from the transmitting entity based on the determined information, and transmitting information relating to the determined maximum number of spatial streams to the transmitting entity.

Certain aspects provide a method for wireless communications. The method generally includes transmitting information to a receiving entity, receiving, from the receiving entity, information relating to a maximum number of spatial streams for a beamformed transmission to be received by the receiving entity, and transmitting spatial streams of the beamformed transmission to the receiving entity based on the received information.

Certain aspects of the present disclosure provide an apparatus for wireless communications. The apparatus generally includes means for determining information relating to transmissions from a transmitting entity, means for determining a maximum number of spatial streams for a beamformed transmission to be received from the transmitting entity based on the information relating to transmissions from a transmitting entity, and means for transmitting information relating to the maximum number of spatial streams to the transmitting entity.

Certain aspects of the present disclosure provide an apparatus for wireless communications. The apparatus generally includes means for transmitting information relating to a transmitting entity to a receiving entity, means for receiving, from the receiving entity, information relating to a maximum number of spatial streams for a beamformed transmission to be received by the receiving entity, and means for transmitting spatial streams of the beamformed transmission to the receiving entity based on the information relating to a maximum number of spatial streams for a beamformed transmission to be received by the receiving entity.

Certain aspects of the present disclosure provide an apparatus for wireless communications. The apparatus generally includes at least one processor configured to determine information relating to transmissions from a transmitting entity, determine a maximum number of spatial streams for a beamformed transmission to be received from the transmitting entity based on the information relating to transmissions from a transmitting entity, and transmit information relating to the maximum number of spatial streams to the transmitting entity, and a memory coupled with the at least one processor.

Certain aspects of the present disclosure provide an apparatus for wireless communications. The apparatus generally includes at least one processor configured to transmit information relating to a transmitting entity to a receiving entity, receiver, from the receiving entity, information relating to a maximum number of spatial streams for a beamformed transmission to be received by the receiving entity, and transmit spatial streams of the beamformed transmission to the receiving entity based on the information relating to a maximum number of spatial streams for a beamformed transmission to be received by the receiving entity, and a memory coupled with the at least one processor.

Certain aspects of the present disclosure provide a program product comprising a computer-readable medium having instructions stored thereon. The instructions are generally executable by one or more processors for determining information relating to transmissions from a transmitting entity, determining a maximum number of spatial streams for a beamformed transmission to be received from the transmitting entity based on the information relating to transmissions from a transmitting entity, and transmitting information relating to the maximum number of spatial streams to the transmitting entity.

Certain aspects of the present disclosure provide a program product comprising a computer-readable medium having instructions stored thereon. The instructions are generally executable by one or more processors for transmitting information relating to a transmitting entity to a receiving entity, receiving, from the receiving entity, information relating to a maximum number of spatial streams for a beamformed transmission to be received by the receiving entity, and transmitting spatial streams of the beamformed transmission to the receiving entity based on the information relating to a maximum number of spatial streams for a beamformed transmission to be received by the receiving entity.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system, in accordance with certain aspects of the present disclosure.

FIG. 2 illustrates various components that may be utilized in a wireless device in accordance with certain aspects of the present disclosure.

FIG. 3 illustrates a block diagram of an Asymmetric Antenna System (AAS) in accordance with certain aspects of the present disclosure.

FIG. 4 illustrates example operations from a receiving entity (e.g., beamformee) perspective, in accordance with certain aspects of the present disclosure.

FIG. 5 illustrates example operations from a transmitting entity (e.g., beamformer) perspective, in accordance with certain aspects of the present disclosure.

FIG. 6 illustrates an example operational mode field, in accordance with certain aspects of the present disclosure.

### DETAILED DESCRIPTION

Certain aspects of the present disclosure provide techniques that give some control over beamforming transmissions to a beamformee (a potential receiving entity of a beamformed transmission). The techniques may, for example, allow a receiving entity capable of performing relatively advanced algorithms to limit a number of spatial streams used in beamformed transmissions from a transmitting entity. This may be beneficial because, beyond a certain number of spatial streams, open loop transmissions may result in better utilization of the advanced algorithms.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Accordingly, while the aspects of the present disclosure are susceptible to various modifications and alternative forms, specific exemplary aspects thereof are shown by way of example in the drawings and will herein be described in detail. It should be understood, however, that there is no intent to limit the disclosure to the particular forms disclosed, but on the contrary, the disclosure is intended to cover all modifications, equivalents, and alternatives falling within the scope of the disclosure. Like numbers may refer to like elements throughout the description of the figures.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality and procedures involved.

### An Example Wireless Communication System

The techniques described herein may be used for various broadband wireless communication systems, including communication systems that are based on a single carrier transmission or based on an Orthogonal Frequency Division Multiplexing (OFDM). Aspects disclosed herein may be advantageous to systems employing Ultra Wide Band (UWB) signals including millimeter-wave signals, wherein a beamforming may be accomplished using a common mode, i.e., using a single carrier. However, the present disclosure is not intended to be limited to such systems, as other coded signals may benefit from similar advantages.

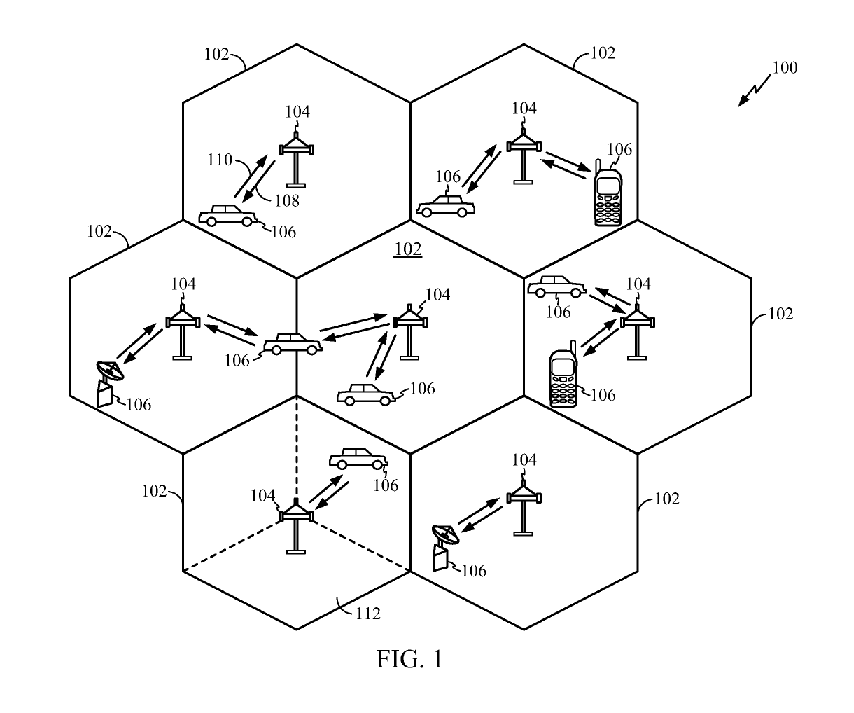

FIG. 1 illustrates an example of a wireless communication system 100 in which aspects of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as a piconet controller (PNC), an access point, a Node B or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with UWB techniques. If this is the case, the wireless communication system 100 may be referred to as an UWB system.

A communication link that facilitates transmission from a base station 104 to a user terminal 106 may be referred to as a downlink (DL) 108, and a communication link that facilitates transmission from a user terminal 106 to a base station 104 may be referred to as an uplink (UL) 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

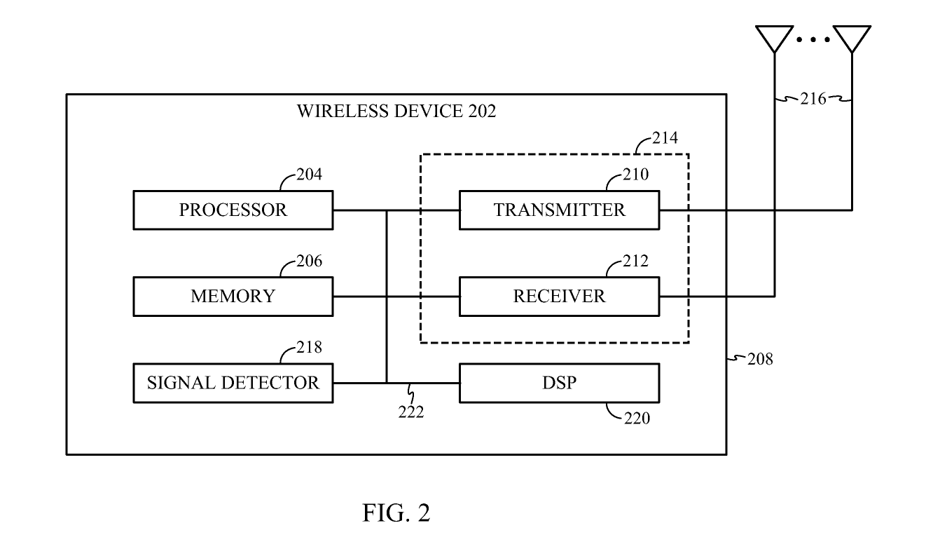

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. A single or a plurality of transmit antennas 216 may be attached to the housing 208 and electrically coupled to the transceiver 214. The wireless device 202 may also include (not shown) multiple transmitters, multiple receivers, and multiple transceivers.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

A transceiver that employs the same antenna(s) for both transmission and reception, while a multipath channel to another transceiver is reciprocal, is referred to as a Symmetric Antenna System (SAS). A transceiver that employs one set of antennas for transmission and another set of antennas for reception or the multipath channel to another transceiver is not reciprocal is referred to as an Asymmetric Antenna System (AAS).

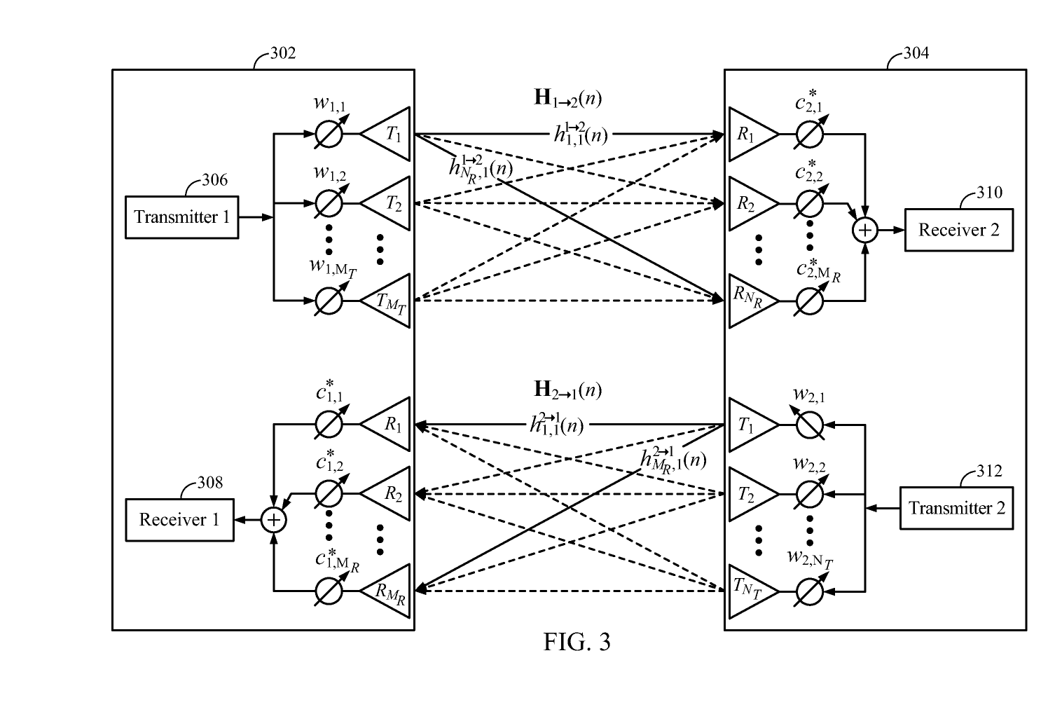

FIG. 3 illustrates a block diagram of the AAS. A first transceiver 302 employs M_{T} transmit antennas and M_{R} receive antennas. A second transceiver 304 employs N_{T} transmit antennas and N_{R} receive antennas.

Channel model H_{1→2} may be used to express the propagation environment when the first transceiver 302 transmits signals to the second transceiver 304. Similarly, channel model H_{2→1} may express the propagation environment when the transceiver 304 transmits signals received by the transceiver 302. The channel models may be used to express any of the possible antenna configurations that may be employed in the related art. Furthermore, the channel models may be used to express different transmission protocols. In one aspect of the present disclosure, OFDM signaling with a cyclic prefix and a fast Fourier transform (FFT) of N subcarriers may employ the same channel model as a transmission that is Single Carrier (SC) with a cyclic prefix having a burst length N. In such cases, it is typical to assume that the cyclic prefix is longer than any multipath delay spread between any transmit-receive pair of antenna elements.

An OFDM symbol stream or SC burst x(t) generated at the first transceiver 302 may be expressed as:

$$x ( t ) = {\sum }_{k = 0}^{N - 1} {s}_{k} δ ( t - {kT}_{c} ) , \qquad ( 1 )$$

where T_{c} is a sample (or chip) duration, and sₖ represents the complex data. The symbol stream may be modulated by a beamforming vector of weights w=[w_{1,1}, w_{1,2}, . . . , w_{1,M}_{_{T}}]^{T} prior to being transmitted into a communication channel.

A multiple input multiple output (MIMO) channel may be expressed by a frequency domain Channel State Information (CSI) at an arbitrary n^{th} frequency bin such as:

H_{1→2}(n)εC^{M}^{_{T}}^{×N}^{_{R}}, (2)

$${H}_{1 \to 2} ( n ) = [ \begin{matrix}{h}_{1 , 1}^{1 \to 2} ( n ) & {h}_{1 , 2}^{1 \to 2} ( n ) & … & {h}_{1 , {N}_{R}}^{1 \to 2} ( n ) \\ {h}_{2 , 1}^{1 \to 2} ( n ) & {h}_{2 , 2}^{1 \to 2} ( n ) & … & {h}_{2 , {N}_{R}}^{1 \to 2} ( n ) \\ ⋮ & ⋮ & ⋱ & ⋮ \\ {h}_{{M}_{T} , 1}^{1 \to 2} ( n ) & {h}_{{M}_{T} , 2}^{1 \to 2} ( n ) & … & {h}_{{M}_{T} , {N}_{R}}^{1 \to 2} ( n )\end{matrix} ] , \qquad ( 3 )$$

where terms h_{i,j}(n) include both transmit and receive filtering, along with the channel impulse response between the j^{th} transmit antenna of the first transceiver 302 and the receive antenna of the second transceiver 304, j=1, 2, . . . , M_{T} and i=1, 2, . . . , N_{R}.

Signals received at the second transceiver 304 may be processed with a combining vector of weights c₂=[c_{2,1} c_{2,2} . . . c_{2,N}_{_{R}}]^{T} in order to produce a combined baseband signal given by:

y(t)=c₂^{H}[Σsₖδ(t−kT_{c}) [symbol] H_{1,2}(t)w₁+b(t)], (4)

where b(t) is an additive white Gaussian noise (AWGN) vector across receive antennas of the second transceiver 304.

The discrete channel model between a transmitter 306 of the first transceiver and a receiver 310 of the second transceiver may be expressed by a single input single output (SISO) channel as:

$${y}_{r} = {c}_{2}^{H} {\sum }_{k = 0}^{L - 1} {H}_{k} {s}_{r - k} {w}_{1} + {c}_{2} {b}_{i} = {\sum }_{k = 0}^{L - 1} {p}_{k} {s}_{r - k} + {b}_{i}^{′} , \qquad ( 5 )$$

where pₖ=c₂^{H}Hₖw₁ and i denotes the sample (or chip) index within an OFDM sample (or a single-carrier burst). The SISO channel may be characterized by a frequency response at frequency bins n=0, 1, . . . , N−1 given by:

pₙ=c₂^{H}H_{1→2}(n)w₁ (6)

The discrete-frequency received signal model may be represented as:

Yₙ=PₙSₙ+Bₙ, (7)

where [S₀, S₁, . . . , S_{N-1}] is the OFDM data symbol (or the FFT of the SC data burst), and [B₀, B₁, . . . , B_{N-1}] is the AWGN vector.

A channel model expressing the channel between a transmitter 312 of the second transceiver 304 to a receiver 308 of the first transceiver 302 may be given by:

Qₙ=c₂^{H}H_{2→1}(n)w₂. (8)

For both OFDM and SC transmissions, the signal-to-noise ratio (SNR) on the n^{th} subcarrier (n=0, 1, . . . , N−1) in both directions of the AAS may be given by:

$${SNR}_{n}^{1 \to 2} = \frac{{E}_{s} {\vert {P}_{n} \vert}^{2}}{{N}_{0}} = \frac{{E}_{s} {\vert {c}_{2}^{H} {H}_{1 \to 2} ( n ) {w}_{1} \vert}^{2}}{{N}_{0}} , \\ {SNR}_{n}^{2 \to 1} = \frac{{E}_{s} {\vert {Q}_{n} \vert}^{2}}{{N}_{0}} = \frac{{E}_{s} {\vert {c}_{1}^{H} {H}_{2 \to 1} ( n ) {w}_{2} \vert}^{2}}{{N}_{0}} . \qquad ( 9 )$$

One objective of the system design may be to determine preferred beamforming vectors w₁ and w₂, and preferred combining vectors c₁ and c₂ that maximize an effective SNR (ESNR) constrained by the alphabets of weight vectors.

The ESNR can be defined as a mapping from the instantaneous SNRs of subcarriers given by equation (9) to an equivalent SNR that takes into account a forward error correction (FEC) employed in the system. There are various methods that can be used for computing the ESNR, such as: calculation of a mean of SNRs over a plurality of subcarriers, a quasi-static method such as the one commonly used in the 3^{rd} generation partnership project 2 (3GPP2) and 1xEV-DV/DO (Evolution Data and Video/Data Optimized) communication systems, a capacity effective signal-to-interference-plus-noise ratio (SINR) mapping (CESM) also used in the 3GPP2 and the 1xEV-DV/DO systems, a CESM technique based on a convex metric that may be employed in the 3GPP2 and the 1xEV-DV/DO systems, and an exponential effective SINR mapping (EESM) used in the 3GPP2 systems.

Different ESNR calculation methods may be utilized for the SC and OFDM systems. For example, a minimum mean square error (MMSE) based SC equalizer typically has an ESNR that can be approximated by the average of SNRs over different bursts. However, OFDM may tend to have an ESNR that may be best approximated using the geometric mean of SNRs over different subcarriers. The various other ESNR calculation methods may be further configured in order to account for additional parameters, such as FEC, receiver imperfections, and/or bit-error rate (BER).

### Signaling to Protect Advanced Receiver Performance in Wireless Local Area Networks (LANs)

As mentioned above, for certain a wireless communication systems with receivers that utilize advanced algorithms, such as Maximum Likelihood (ML), beyond a certain number of spatial streams, it may actually be harmful for the receiver if a Tx beamformed transmission is carried out as compared to using an open loop transmission. The reason for this may be because typically if a transmitter has already cleaned up interference across streams, the power of an advanced receiver may be wasted.

In an 802.11n system, the beamformee is in control of sounding feedback dimension. Thus, in such a system including an advanced receiver (e.g. ML receiver), the receiver may intentionally control the feedback dimension, so that the beamformer does not transmit beyond a certain number of spatial streams using transmit beamforming. However, in some current and proposed systems, (e.g., 802.11ac systems), this may no longer be the case as an access point (AP) may be given control of the feedback dimension with introduction of multi user multiple-input multiple-output MU-MIMO.

According certain aspects, however, a mechanism for signaling is proposed that may help protect performance of advanced receivers when an AP is transmitting to them using single user transmit beamformed (SU Tx BF) transmissions.

The techniques presented herein may be utilized to advantage, for example, when a station (STA) may not prefer SU Tx BF transmissions beyond a certain number of spatial streams (SS). For example, in case of an AP with 4 transmit antennas (4Tx) a station with 4 receive antennas (4 Rx) with an ML receiver may be better off receiving a 4ss open loop transmission, rather than a Tx BF transmission.

According to certain aspects, although single user (SU) type feedback may be under complete control of a beamformee, this may not necessarily be the case for MU type feedback. For example, an AP may re-use MU type feedback to carry out an SU transmission, which may present a challenge for a station to control how many streams are utilized for Tx beamforming.

According to certain aspects, a solution may include giving the STA control over the maximum number of spatial streams it wants to receive in an SU Tx BF transmission.

According to certain aspects, a station may determine a maximum number of spatial streams to receive for single user (SU) beamformed transmissions from an AP based on information regarding the AP. The information may be gathered during an exchange of capabilities between the station and AP. This information may include information regarding a number of transmit antennas or a number of sounding long training fields (LTFs).

In an aspect of the present disclosure, one or more fields or sub-fields may be provided to explicitly indicate such information. As an example, these new sub-fields may include one or both of the following new sub-fields for Tx BF capabilities: an information field for maximum number of desired spatial streams (Max Nss) to be received for SU BF, indicating receive side capability; and an information field for a number of beamforming Tx antennas, indicating transmit side capability (e.g., the Transmit BF capability field).

According to certain aspects, an access point (AP) transmits information relating to a number of transmit antennas of the AP to a station (STA). In certain aspects the AP transmits the information relating to the number of transmit antennas in an information field of a transmission indicating transmit side capability.

The STA may determine a maximum number of spatial streams it may receive for beamformed transmission from the AP, based on the received antenna information. The STA may then transmit feedback information relating to the determined maximum number of spatial streams back to the AP. In certain aspects, the STA transmits the feedback information relating to the determined maximum number of spatial streams in an information field of a transmission indicating receive side capability. The AP may receive the feedback information from the STA and transmit spatial streams of the beamformed transmission to the STA based on the received feedback information.

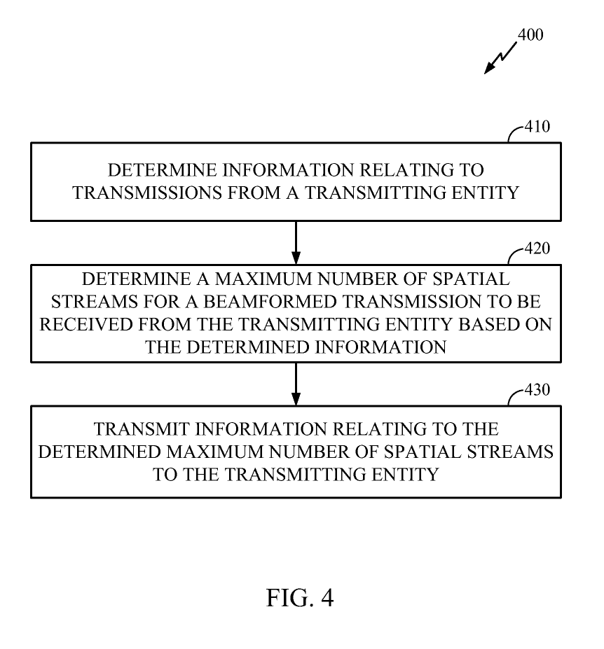

FIG. 4 illustrates example operations 400 for protecting advanced receiver performance, from a beamformee perspective, in accordance with certain aspects of the present disclosure. The operations may be performed, for example, by a station with advanced receiver capabilities.

The operations 400 begin, at 402, by determining information relating to transmissions from a transmitting entity. At 404, the station may determine a maximum number of spatial streams for a beamformed transmission to be received from the transmitting entity based on the determined information. At 406, the station may transmit information relating to the determined maximum number of spatial streams to the transmitting entity.

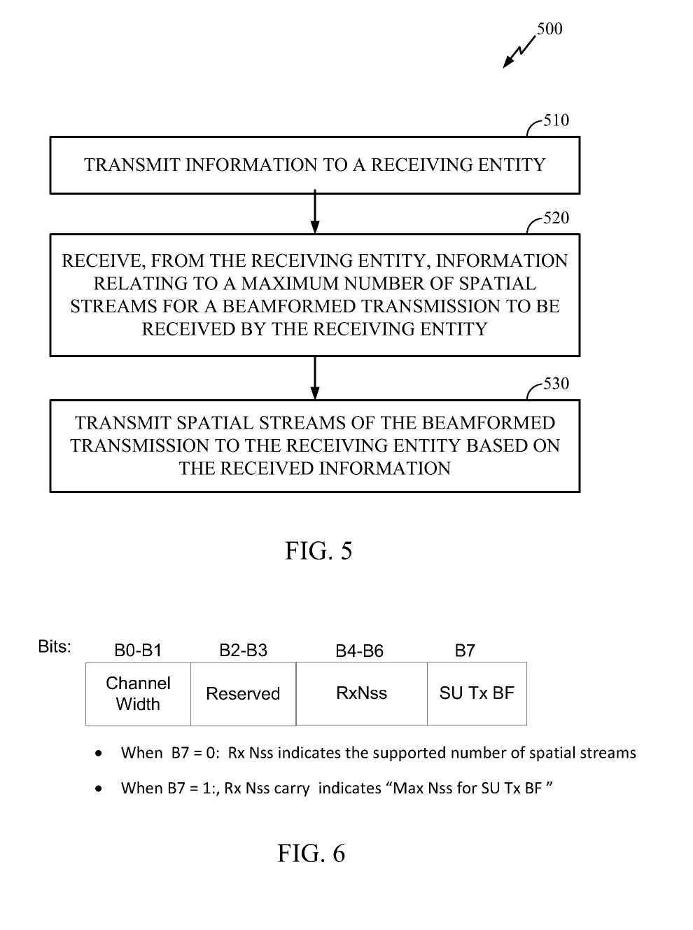

FIG. 5 illustrates example operations 500 for protecting advanced receiver performance, from a beamformer perspective, in accordance with certain aspects of the present disclosure. The operations may be performed, for example, by an AP in communication with stations that have advanced receiver capabilities.

The operations 500 being, at 502, by transmitting information to a receiving entity. At 504, the AP receives, from the receiving entity, information relating to a maximum number of spatial streams for a beamformed transmission to be received by the receiving entity. At 506, the AP transmits spatial streams of the beamformed transmission to the receiving entity based on the received information.

In some cases, the station may specify the “Max Nss for SU BF” using a format used for MU type feedback with a field as part of capability exchange. According to certain aspects, a station may observer the number of sounding LTFs and decides a “Max Nss for SU BF” based on that number and based upon its receiver implementation. For example, it may limit the number of spatial streams if it implements an advanced receive algorithm, such as ML.

According to certain aspects, a sub-field may be provided as a mechanism for an AP to advertise its “number of sounding LTFs.” Such a sub-field may be provided in a Transmit BF capability indication.

According to certain aspects, a station may set (and adjust) its “Max Nss for SU BF” as follows. The station may first set “Max Nss for SU BF” to an initial default value (e.g., initially assuming the initial default value before updating based on AP capability). Once the AP capability is known, the station may update this value (from the initial default setting) and later convey the updated value to the AP.

According to certain aspects, an Operating Mode field in a Notify Operating Mode frame may be used for conveying “Max Nss for SU BF” to the AP. In some cases, an existing format of an Operating Mode field may be used, but with previously reserved bits used in a new manner.

For example, as illustrated in FIG. 6, a previously reserved bit (Bit 7) may be used as an indication of whether bits of a sub-field (R_{X}N_{SS}) indicate a supported number of spatial streams (as in a previous format) or indicate “Max Nss for SU BF.” As illustrated in FIG. 6, when B7=0, Rx Nss indicates the supported number of spatial streams, when B7=1, Rx Nss indicates “Max Nss for SU Tx BF.”

As described above, techniques presented herein provide a signaling mechanism that may allow a beamformee (e.g., a station with an advanced receiver) to control beamforming to limit a number of spatial streams in a beamformed transmission to better match its receiver capabilities.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may have corresponding counterpart means-plus-function components that are configured to perform the operations.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and BLU-RAY® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

The techniques provided herein may be utilized in a variety of applications. For certain aspects, the techniques presented herein may be incorporated in an access point or other type of wireless device with processing logic and elements to perform the techniques provided herein

What is claimed is:

1. A method of wireless communications, comprising:
determining information relating to transmissions from a transmitting entity;
determining a maximum number of spatial streams for a beamformed transmission to be received from the transmitting entity based on the information relating to transmissions from a transmitting entity; and
transmitting information relating to the maximum number of spatial streams to the transmitting entity.

2. The method of claim 1, wherein the information relating to transmissions from a transmitting entity comprises information regarding a number of transmit (TX) antennas of the transmitting entity.

3. The method of claim 1, wherein the information relating to transmissions from a transmitting entity comprises a number of sounding long training fields (LTFs).

4. The method of claim 1, wherein transmitting information relating to the maximum number of spatial streams to the transmitting entity comprises:
transmitting the information relating to the maximum number of spatial streams in an operating mode field.

5. The method of claim 4, further comprising:
setting a bit in the operating mode field to a first value that indicates the operating mode field comprises a set of bits indicating the maximum number of spatial streams.

6. The method of claim 5, wherein:
setting the bit to a second value indicates the set of bits indicates a supported number of spatial streams.

7. The method of claim 1, wherein the maximum number of spatial streams comprises a maximum number of spatial streams for a single user (SU) beamformed transmission.

8. The method of claim 1, wherein the information relating to transmissions from a transmitting entity is received in an information field of a transmission which indicates transmit side capability.

9. The method of claim 1, wherein the information relating to maximum number of spatial streams is transmitted in an information field of a transmission which indicates receiver side capability.

10. The method of claim 1, comprising:
initially assuming a default value for the maximum number of spatial streams for a beamformed transmission to be received from the transmitting entity, prior to determining the information related to transmission from the transmitting entity.

11. A method of wireless communication by a transmitting entity, comprising:
transmitting information relating to the transmitting entity to a receiving entity;
receiving, from the receiving entity, information relating to a maximum number of spatial streams for a beamformed transmission to be received by the receiving entity; and
transmitting spatial streams of the beamformed transmission to the receiving entity based on the information relating to a maximum number of spatial streams for a beamformed transmission to be received by the receiving entity.

12. The method of claim 11, wherein the information relating to the transmitting entity comprises information regarding a number of transmit (TX) antennas of the transmitting entity.

13. The method of claim 11, wherein transmitting information relating to the transmitting entity comprises transmitting a number of sounding long training fields (LTFs).

14. The method of claim 11, wherein the receiving comprises:
receiving the information relating to the determined maximum number of spatial streams in an operating mode field.

15. The method of claim 14, further comprising:
setting a bit in the operating mode field to a first value that indicates the operating mode field comprises a set of bits indicating the maximum number of spatial streams.

16. The method of claim 15, wherein:
setting the bit to a second value indicates the set of bits indicates a supported number of spatial streams.

17. The method of claim 11, wherein the maximum number of spatial streams comprises a maximum number of spatial streams for a single user (SU) beamformed transmission.

18. The method of claim 11, wherein the information relating to transmissions from the transmitting entity is transmitted in an information field of a transmission which indicates transmit side capability.

19. The method of claim 11, wherein the information relating to maximum number of spatial streams is received in an information field of a transmission which indicates receiver side capability.

20. An apparatus for wireless communications, comprising:
means for determining information relating to transmissions from a transmitting entity;
means for determining a maximum number of spatial streams for a beamformed transmission to be received from the transmitting entity based on the information relating to transmissions from a transmitting entity; and
means for transmitting information relating to the maximum number of spatial streams to the transmitting entity.

21. The apparatus of claim 20, wherein the information relating to transmissions from a transmitting entity comprises information regarding a number of transmit (TX) antennas of the transmitting entity.

22. The apparatus of claim 20, wherein the information relating to transmissions from a transmitting entity comprises a number of sounding long training fields (LTFs).

23. The apparatus of claim 20, wherein the means for transmitting information relating to the maximum number of spatial streams to the transmitting entity comprises:
means for transmitting the information relating to the maximum number of spatial streams in an operating mode field.

24. The apparatus of claim 23, further comprising:
means for setting a bit in the operating mode field to a first value that indicates the operating mode field comprises a set of bits indicating the maximum number of spatial streams.

25. The apparatus of claim 24, wherein:
setting the bit to a second value indicates the set of bits indicates a supported number of spatial streams.

26. The apparatus of claim 20, wherein the maximum number of spatial streams comprises a maximum number of spatial streams for a single user (SU) beamformed transmission.

27. The apparatus of claim 20, wherein the information relating to transmissions from a transmitting entity is received in an information field of a transmission which indicates transmit side capability.

28. The apparatus of claim 20, wherein the information relating to maximum number of spatial streams is transmitted in an information field of a transmission which indicates receiver side capability.

29. The apparatus of claim 20, comprising:
means for initially assuming a default value for the maximum number of spatial streams for a beamformed transmission to be received from the transmitting entity, prior to determining the information related to transmission from the transmitting entity.

30. An apparatus, comprising:
means for transmitting information relating to a transmitting entity to a receiving entity;
means for receiving, from the receiving entity, information relating to a maximum number of spatial streams for a beamformed transmission to be received by the receiving entity; and
means for transmitting spatial streams of the beamformed transmission to the receiving entity based on the information relating to a maximum number of spatial streams for a beamformed transmission to be received by the receiving entity.

31. The apparatus of claim 30, wherein the information relating to the transmitting entity comprises information regarding a number of transmit (TX) antennas of the transmitting entity.

32. The apparatus of claim 30, wherein the means for transmitting information relating to the transmitting entity comprises means for transmitting a number of sounding long training fields (LTFs).

33. The apparatus of claim 30, wherein the means for receiving comprises:
means for receiving the information relating to the determined maximum number of spatial streams in an operating mode field.

34. The apparatus of claim 14, further comprising:
means for setting a bit in the operating mode field to a first value that indicates the operating mode field comprises a set of bits indicating the maximum number of spatial streams.

35. The apparatus of claim 15, wherein:
setting the bit to a second value indicates the set of bits indicates a supported number of spatial streams.

36. The apparatus of claim 30, wherein the maximum number of spatial streams comprises a maximum number of spatial streams for a single user (SU) beamformed transmission.

37. The apparatus of claim 30, wherein the information relating to transmissions from the transmitting entity is transmitted in an information field of a transmission which indicates transmit side capability.

38. The apparatus of claim 30, wherein the information relating to maximum number of spatial streams is received in an information field of a transmission which indicates receiver side capability.

39. An apparatus for wireless communications, comprising:
at least one processor configured to determine information relating to transmissions from a transmitting entity, determine a maximum number of spatial streams for a beamformed transmission to be received from the transmitting entity based on the information relating to transmissions from a transmitting entity, and transmit information relating to the maximum number of spatial streams to the transmitting entity; and
a memory coupled with the at least one processor.

40. An apparatus, comprising:
at least one processor configured to transmit information relating to a transmitting entity to a receiving entity, receiver, from the receiving entity, information relating to a maximum number of spatial streams for a beamformed transmission to be received by the receiving entity, and transmit spatial streams of the beamformed transmission to the receiving entity based on the information relating to a maximum number of spatial streams for a beamformed transmission to be received by the receiving entity; and
a memory coupled with the at least one processor.

41. A program product comprising a computer-readable medium having instructions stored thereon, the instructions executable by one or more processors for:
determining information relating to transmissions from a transmitting entity;
determining a maximum number of spatial streams for a beamformed transmission to be received from the transmitting entity based on the information relating to transmissions from a transmitting entity; and
transmitting information relating to the maximum number of spatial streams to the transmitting entity.

42. A program product comprising a computer-readable medium having instructions stored thereon, the instructions executable by one or more processors for:
transmitting information relating to a transmitting entity to a receiving entity;
receiving, from the receiving entity, information relating to a maximum number of spatial streams for a beamformed transmission to be received by the receiving entity; and
transmitting spatial streams of the beamformed transmission to the receiving entity based on the information relating to a maximum number of spatial streams for a beamformed transmission to be received by the receiving entity.
